(19) United States
(12) Patent Application Publication
(10) Pub. No.: US 2024/0319670 A1
(43) Pub. Date: Sep. 26, 2024

(54) SYSTEMS AND METHODS FOR LIGHT SHEETS

(71) Applicants: PRESIDENT AND FELLOWS OF HARVARD COLLEGE, Cambridge, MA (US); University of São Paulo, São Carlos (BR); University of Campinas, Campinas (BR)

(72) Inventors: Ahmed H. DORRAH, Cambridge, MA (US); Federico CAPASSO, Cambridge, MA (US); Leonardo A. AMBROSIO, São Carlos (BR); Michel ZAMBONI-RACHED, Campinas (BR); Priyanuj BORDOLOI, Palo Alto, CA (US); Vinicius S. DE ANGELIS, São Carlos (BR); Jhonas Olivati DE SARRO, São Carlos (BR)

(73) Assignees: PRESIDENT AND FELLOWS OF HARVARD COLLEGE, Cambridge, MA (US); University of São Paulo, São Carlos (BR); University of Campinas, Campinas (BR)

(21) Appl. No.: 18/607,275

(22) Filed: Mar. 15, 2024

Related U.S. Application Data
(60) Provisional application No. 63/453,015, filed on Mar. 17, 2023.

(51) Int. Cl. G03H 1/22; G03H 1/00; G03H 1/02

(52) U.S. Cl. CPC G03H 1/2205; G03H 1/0005; G03H 2001/0088; G03H 2001/0224; G03H 2001/2218

(57) ABSTRACT

A system can include a wavefront-shaping device. The wavefront-shaping device can project one or more light sheets along an optical path. The one or more light sheets can include one or more light threads. Each of the one or more light threads can be non-diffracting and structured along the optical path. At least one plane of the one or more light sheets can be non-parallel to a plane of the wavefront-shaping device.

### CROSS-REFERENCE TO RELATED PATENT APPLICATION

This application claims the benefit and priority of U.S. Provisional Patent Application No. 63/453,015, filed on Mar. 17, 2023, the entirety of which is incorporated by reference herein.

### GOVERNMENT RIGHTS

This invention was made with government support under FA9550-21-1-0312 and FA9550-22-1-0243 awarded by U.S. Air Force Office of Scientific Research (AFOSR) and under N00014-20-1-2450 awarded by U.S. Office of Naval Research (NAVY/ONR). The government has certain rights in this invention.

### TECHNICAL FIELD

The present application relates generally to holography and 3D volumetric displays.

### BACKGROUND

Three-dimensional scenes can be projected.

### SUMMARY

At least one aspect of the present disclosure is directed to a system. The system can include a wavefront-shaping device. The wavefront-shaping device can project one or more light sheets along an optical path. The one or more light sheets can include one or more light threads. Each of the one or more light threads can be non-diffracting and structured along the optical path. At least one plane of the one or more light sheets can be non-parallel to a plane of the wavefront-shaping device.

Another aspect of the present disclosure is directed to a method. The method can include projecting, by a wavefront-shaping device, one or more light sheets along an optical path. The one or more light sheets can include one or more light threads. Each of the one or more light threads can be non-diffracting and structured along the optical path. At least one plane of the one or more light sheets can be non-parallel to a plane of the wavefront-shaping device.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1A illustrates a Fourier holography.

FIG. 1B illustrates Fresnel holography.

FIG. 1C illustrates holographic light sheets, according to an embodiment.

FIG. 1D illustrates 3D light sheet holography, according to an embodiment.

FIGS. 2A-2D illustrates holographic light sheets, according to an embodiment.

FIGS. 3A-3E illustrates generation of 2D holographic light sheets, according to an embodiment.

FIGS. 4A-4D illustrate assembly of 2D holographic light sheets to construct volumetric scenes, according to an embodiment.

FIGS. 5A-5D illustrates projection of 2D images with Fresnel holography.

FIGS. 6A-6D illustrate projection of 2D images with holographic light sheets, according to an embodiment.

FIG. 7 illustrates the depth of field for an image plane.

FIG. 8 illustrates unequal separation for multi-plane projection, according to an embodiment.

FIGS. 9A and 9B illustrate decomposition of a Surface Frozen Wave, according to an embodiment.

FIGS. 10A and 10B illustrate scaling of the projected hologram, according to an embodiment.

FIGS. 11A-11C illustrate projection of 3D spheres with improved aspect ratio using holographic light sheets, according to an embodiment.

FIGS. 12A and 12B illustrates a non-paraxial 3D sphere, according to an embodiment.

FIGS. 13A and 13B illustrate improvements in reconstruction quality, according to an embodiment.

FIGS. 14A-14D illustrate projection of 2D images with Fresnel holography.

FIGS. 15A-15D illustrate projection of 2D images with holographic light sheets, according to an embodiment.

FIGS. 16A and 16B illustrate complex amplitude modulation versus phase-only reconstruction, according to an embodiment.

FIGS. 17A-17C illustrate the energy distribution in holographic light sheets, according to an embodiment.

FIG. 18 illustrate the experimental reconstruction of a 3D hollow sphere while sampling intermediate layers, according to an embodiment.

FIG. 19 illustrates multi-chromatic holographic light sheets, according to an embodiment.

FIGS. 20A and 20B illustrate construction of 3D dark regions, according to an embodiment.

FIG. 21 illustrates a method of forming light sheets, according to an embodiment.

Like reference numbers and designations in the various drawings indicate like elements.

### DETAILED DESCRIPTION

Following below are more detailed descriptions of various concepts related to, and implementations of, methods, apparatuses, and systems for light sheets. The various concepts introduced above and discussed in greater detail below may be implemented in any of a number of ways, as the described concepts are not limited to any particular manner of implementation. Examples of specific implementations and applications are provided primarily for illustrative purposes.

Projecting high-quality three-dimensional (3D) scenes via computer-generated holography (CGH) can be a sought-after goal for virtual and augmented reality, human-computer interaction, and interactive learning. 3D objects can be constructed from a single hologram by cascading a stack of 2D scenes along the optical path and perpendicular to it. The spatial separation between those scenes, however, can be fundamentally constrained by the numerical aperture of the hologram, limiting the axial resolution and depth perception of the generated 3D image. The systems and methods of the present disclosure are directed to a class of holograms which projects a desired scene onto two-dimensional (2D) sheets oriented perpendicular to the plane of the display screen, thus enabling continuous reconstruction of the object along the optical path. To achieve this, the target scene can be decomposed into threads of light (e.g., arrays of non-diffracting pencil-like beams whose envelope can be locally structured along the propagation direction), at-will. Using a spatial light modulator, 2D scenes can be projected onto the plane normal to the hologram and, by stacking multiple 2D sheets in parallel, 3D objects can be constructed with high fidelity and low cross-talk. CGHs of this kind can open new routes to realistic 3D holography and can be deployed in wearable smart glasses, portable devices, and wide-angle volumetric displays.

In contrast to photography which stores a fixed view of a scene using a lens, a hologram can record the entire wavefront scattered from an object, thus enabling more realistic reconstruction of the scene in terms of depth perception and parallax. When suitably illuminated, holograms can provide true-to-life playback of a 3D target object which can be observed with the naked eye from different viewing angles. Holography can be used for improving electron microscopy. Holography can have applications in volumetric displays, optical data storage, biological imaging, laser beam shaping, optical tweezers and micromanipulation, virtual and augmented reality, thanks to the abundance of coherent sources and computer-generated holograms. The latter can be recorded (in transmission or reflection), for example, using liquid crystal displays, digital micro mirror devices, erasable photorefractive polymers, stretchable materials, and metasurfaces.

The quality of a holographic display can rely on its ability to exhibit certain sources of information (e.g., cues) which collectively stimulate depth perception in the human visual system, allowing for the derivation and understanding of the structure and depth of a natural complex scene. This can include relative object sizes, densities, heights, and aerial perspective in addition to more subtle cues such as occlusion (e.g., hiding one object behind another), parallax (e.g., apparent displacement of an object depending on the observer's point-of-view), binocular disparity (e.g., changing relative position of an object as it is projected on each retina, separately), and convergence/accommodation (e.g., independent focusing on close/distant objects).

Decades of efforts have pushed the frontiers of holography in an attempt to achieve adequate compromise between these cues, ultimately producing photo-realistic 3D images, aided by the progress in wavefront shaping tools and computer-generated holograms. Central to these advances can include the ability to project a stack of images, with tight separation in between, to construct a true volumetric scene. Early pursuits of this goal started, for example, by assembling composite holographic stereograms in which a sequence of projections of 3D perspectives is first calculated, with Fourier-based transform, then grouped into a single CGH that reconstructs the target image, albeit in 2D, with a wide angle of view. Iterative approaches using Fresnel holography (e.g. , the ping-pong algorithm) can be used to generate two noiseless image intensities at two depth locations from a single computer hologram, by treating the phases relating the two images as a design degree-of-freedom. Extensions of this method that project speckle-free images onto three planes can be demonstrated. Other approaches based on integral imaging and dense ray sampling can reproduce an image with full parallax by deploying a two-dimensional array of microlenses which captures elemental images of the object as seen from the viewpoint of that lens's location.

Horizontal and/or vertical parallax can be achieved through stereograms, whereas true (3D) depth can be realized with multi-layered holography which now extends beyond several planes. In parallel to these efforts, the holographic display (e.g., recording medium) itself can be developed to refresh the projected holographic scene as a function of time, for example, using updatable photorefractive polymers, or scannable photophoretic displays. Other investigations can study spatiotemporal focusing using pulsed laser sources, or enhancing the hologram resolution using non-linear and plasmonic metasurfaces, in addition to mitigating the trade-off between image size and view angle using speckle holography and the synthetic aperture technique. As this field started to mature, the quest for fast hologram computation have also emerged. This can be met by deploying look-up tables, accelerated GPUs and, more recently, using machine learning and deep neural networks.

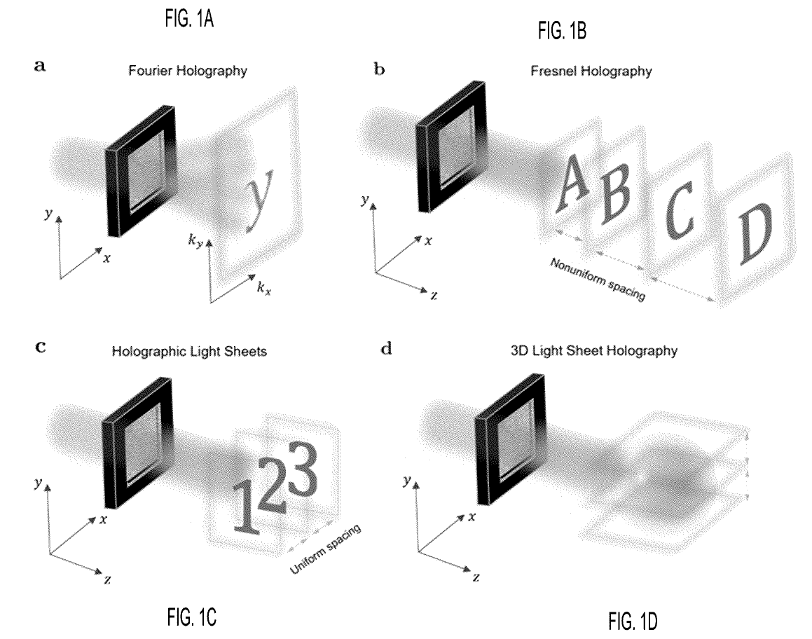

Several limitations are still underway to project realistic 3D scene. For example, Fourier holograms based on the kinoform technique and its extensions can primarily project objects within a short depth-of-focus at the far-field region (FIG. 1A), or in the vicinity of the focal plane of a lens, making them better suited for microscopy—a limitation that can be addressed by Fresnel holography which can project arbitrarily large images with 3D depth. Fresnel holography, however, cannot maintain a uniform separation between the projected images without introducing cross-talk. This can be mitigated by preconditioning the wavefront such that it reduces to a Fourier hologram, locally, at the plane of interest while adding random phase values to render quasi orthogonal set of images with minimum interference. Owing to the finite aperture size, however, this approach (and Fresnel holography in general) still can mandate a progressively larger separation between the images projected at longer distance, as depicted in FIG. 1B, leading to non-uniform sampling of the 3D scene in the axial direction which in turn hinders many applications. The projection quality can be improved with cascaded diffractive elements or cylindrical holograms, which often add complexity and cost. In short, a compact holographic mechanism that can enable accurate reconstruction of a 3D object using a single hologram, while achieving continuous depth with high axial resolution, remains elusive.

The systems and methods of the present disclosure are directed to an approach to holography that addresses the above constraints. In contrast to the wide body of literature that seeks to project one or more scenes onto the plane(s) parallel to the display, here, each scene can be projected onto a flat light sheet, oriented perpendicular to the display as illustrated in FIG. 1C. This can allow the target image to be sampled continuously along the propagation direction with high axial resolution. This can be achieved by decomposing any desired target image into threads of light (e.g., light threads, light segments, light elements, etc.) whose intensity can be structured at-will along the optical path. By assembling an array of those light threads, 2D sheets can be synthesized which can then be tightly stacked, in parallel, with equal separation, to construct the desired 3D scene with high fidelity, low cross-talk, and long depth-of-field (FIG. 1D). This approach can provide new way to achieve realistic 3D holography. It can also be integrated in volumetric displays by projecting the light sheets in lightly scattering media or onto a stack of LCD panels, thus visualizing a volumetric object from virtually any angle. Furthermore, this formulation can be based on non-iterative closed form analytic solution, providing calculable computation cost. This technique can open new routes to real-time 3D holography, augmented and virtual reality and wide-angle volumetric displays.

FIGS. 1A-1D illustrates different approaches to holographic projection. FIG. 1A illustrates Fourier holography, which can project a 2D image in the far-field with limited depth-of-field. FIG. 1B illustrates multi-plane Fresnel holography, which can project 2D images at different depths along the optical path, albeit with different sizes due to diffraction. To avoid cross-talk, images projected at further distances can maintain larger separation in between, limiting the axial resolution and depth perception. FIG. 1C illustrates holographic light sheets, which can include a class of holograms which can project multiple images onto parallel layers oriented perpendicular to the hologram plane while preserving uniform separation in between. FIG. 1D illustrates a 3D scene, which can be decomposed into a stack of 2D holographic light sheets which can be oriented horizontally (as shown) or vertically, providing realistic reconstruction of the target object by projecting it with continuous depth along the axial direction.

A thread of light that can be structured along the optical path can be created. Several threads can be assembled into 2D sheets that can be stacked to form the desired volumetric scene. The light threads can take the form of a superposition of non-diffracting beams with different tilt angles which can constructively or destructively interfere at precise locations along the axial direction to sculpt any predetermined intensity profile. By combining multiple threads in parallel, the target scene can be rastered, row-by-row, like in 3D printing. More specifically, each thread can include a discrete superposition of forward propagating Bessel modes with different cone angles (e.g., propagation constants), weighted by carefully chosen complex coefficients (which can vary in amplitude and phase). This can allow for full control over the intensity of the resulting envelope at each propagation distance. This approach can include a class of co-propagating Bessel modes called Frozen Waves. Bessel beams can have quasi diffraction-less and self-healing properties which can allow the beam to reconstruct its central spot even if obstructed by an obstacle. Robust 3D holograms with long depth-of-field can be generated. By assembling many Frozen Waves into a 2D sheet, a surface of arbitrary intensity profile, oriented along the propagation direction, can be constructed with full control over the intensity at each point.

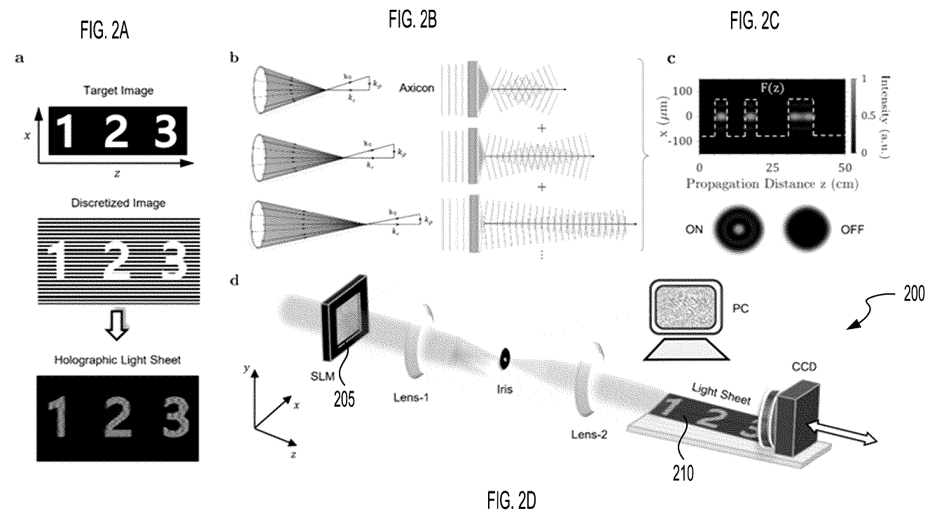

To illustrate this concept, the target image shown in FIG. 2A can be projected onto the horizontal (x-z) plane. This 2D image can be discretized into parallel threads of light that travel along the z-direction. The envelope of each light thread can be designed to follow the intensity profile of the target image, row-by-row. Each light thread can include a superposition of Bessel beams with equal separation in the k_{z}(k_{z} being the longitudinal wavenumbers of each Bessel beam)—a superposition which can be physically realized using axicons with slightly different cone angles, as illustrated in FIG. 2B. Weighted by different complex coefficients, these co-propagating modes can interfere along the optical path to construct any arbitrary longitudinal intensity profile given by the function F(z), as depicted in FIG. 2C. This approach can be used in free space propagation and can also extend to cases in which the propagation medium is characterized by complex refractive index. The underlying mechanism of this axial intensity modulation can rely on the interplay between the energy in the center spot of the beam and its outer rings. For example, when the central spot “switches off”, its energy can be dispersed onto the outer rings of the beam, albeit with less intensity, thus conserving the global energy at each cross section, as shown in the bottom insets of FIG. 2C.

The mathematical formulation of the surface Frozen Wave theory and the calculation of the complex weights of each Bessel mode in the superposition can be described. The system and methods of the present disclosure can provide the first experimental demonstration of 2D and 3D holographic light sheets and the examination of their feasibility using liquid crystal displays as well as their advantages compared to multi-plane Fresnel holography.

The holographic sheets can be generated using programmable phase-only spatial light modulators. The target image, the number of light threads (e.g., Frozen Waves) over which the image can be discretized, the diameter of the light threads, and the separation in between can be specified. The target images can be discretized into roughly 80 Frozen Waves, each with a center spot radius of 30 μm, and a gap of 45 μm in between. Different combinations of these values can ultimately define the resolution of the projected image and can be practically limited by the implementation medium. The superposition of Bessel beams including each Frozen Wave can be calculated. The Frozen Waves can be added, spatially offset with respect to each other by a displacement of 45 μm, center-to-center. By solving for this superposition at the z=0 plane, the complex transverse profile of the hologram in the x-y plane can be obtained. This can include the initial field distribution which can propagate in space to eventually construct the target image in the x-z plane. Since the SLM, as well as most holographic media, can primarily modulate the phase of an incident wavefront without altering its amplitude, a phase retrieval algorithm can be deployed to convert the complex (amplitude and phase) field distribution into a phase-only mask. This phase-mask can then be addressed onto the SLM. A phase-only reflective SLM (Santec SLM-200) with 1920×1200 pixel resolution and 8 μm pixel pitch can be used. The former parameter can define the aperture size of the hologram, which dictates the longitudinal extent of the projected image, whereas the latter can set an upper limit on the highest spatial frequency of the initial field distribution, which determines the largest cone angle for the Bessel modes in the superposition.

The desired complex profile can be generated at the output focal plane of a 4-ƒ imaging system located after the SLM. The role of the 4-ƒ system can be twofold: a) to filter the desired pattern from the zero-th order beam, and b) to image the filtered pattern onto the CCD. The desired hologram can be encoded off-axis, by adding a blazed grating profile to the CGH, to spatially separate it from the unmodulated zero-th order beam (which can arise due to the finite fill factor of the SLM). FIG. 2D depicts the experimental setup described above, where the z=0 plane lies at the output focal plane of the 4-ƒ system. To construct the longitudinal profile of the light sheets, the transverse profile of the output pattern at each z-plane can be recorded, with a CCD, then 1D slices from those images can be stitched (via post processing) to reconstruct the image in the x-z plane. In the following, different examples of light sheets created by this approach can be demonstrated and how it could be extended to reconstruct 3D objects can be shown.

FIGS. 2A-2D illustrates holographic light sheets. FIG. 2A illustrates a target image “1 2 3.” The target image can be discretized, row-by-row, into a stack of parallel lines. These lines can then be holographically reconstructed via threads of light in the (x-z plane). FIG. 2B illustrates light threads. Each forward propagating light thread can be created from a superposition of non-diffracting beams (Bessel modes), which can be generated by axicons of slightly different cone angles. Here, k_{z} and kₚ denote the longitudinal and transverse wavenumbers, k₀=2π/λ. FIG. 2C illustrates a superposition of co-propagating Bessel beams with different cone angles (wavevectors), which can be designed to modulate its intensity profile, spatially, along the z-direction, following the target profile specified by F(z). Transverse cross sections of the beam at two different z-planes can exhibit the intensity modulation in the beam's center.

FIG. 2D illustrates a system 200. The system 200 can include a wavefront-shaping device 205. The wavefront-shaping device 205 can include at least one of a diffractive optic, a spatial light modulator, a metasurface, or a digital micromirror device. The wavefront shaping device 205 can include a plane. The plane of the wavefront-shaping device can be perpendicular to an optical path. The wavefront-shaping device can shape the wavefront of light.

The system 200 include one or more light sheets 210 (e.g., holographic light sheets). For example, the system 200 can generate the light sheets 210. The wavefront-shaping device 205 can project the one or more light sheets 210. For example, the wavefront-shaping device 205 can project the one or more light sheets 210 along the optical path. At least one plane of the one or more light sheets 210 can be non-parallel to a plane of the wavefront-shaping device 205. The at least one plane of the one or more light sheets 210 can be parallel to the optical path. The light sheet 210 include light oriented in a plane. The light sheet 210 include light confined to two dimensions.

The one or more light sheets 210 can include a first light sheet. The first light sheet can be defined by a first plane. The one or more light sheets 210 can include a second light sheet. The second light sheet can be proximate the first light sheet. The second light sheet can be defined by a second plane. The first plane and the second plane can be perpendicular to the plane of the wavefront-shaping device 205. The first plane can be non-parallel to the second plane. The second light sheet can be separated from the first light sheet by a first distance. The first distance can be in a range of one wavelength to 10,000 times the wavelength. The one or more light sheets 210 can include a third light sheet. The third light sheet can be separated from the second light sheet by a second distance. The first distance and the second distance can be equal. The first distance and the second distance can be different. The one or more light sheets 210 can be curved. The one or more light sheets 210 can planar. A three-dimensional object can be spatially reconstructed by the one or more light sheets.

The one or more light sheets 210 can include one or more light threads. Each of the one or more light threads can be non-diffracting. Each of the one or more light threads can be structured along the optical path. Each of the one or more light threads can be formed from a superposition of non-diffracting beams. The one or more light threads can include light having one or more wavelengths. Each of the one or more light threads can be formed from a superposition of localized beams. The light thread can include light confined to one dimension.

The system 200 can include one or more transparent sheets. The one or more transparent sheets can include the one or more light sheets 210. At least one plane of the one or more transparent sheets can be non-parallel to the plane of the wavefront-shaping device. The one or more transparent sheets can be configured to scatter light from the one or more light sheets.

Holographic light sheets can be generated by encoding a phase-only computer-generated hologram onto a spatial light modulator (SLM). A horizontally polarized light beam (532 nm) can be expanded and collimated, approximating quasi plane wave-like illumination onto the SLM. The output beam from the SLM can be imaged and filtered using a 4-ƒ lens system to get rid of higher diffraction orders and project the desired image onto a CCD. The CCD can be mounted on a translational stage to record the generated pattern at z plane. By stacking 1D slices (at the plane y=0) from these images in the axial direction, the longitudinal profile of the hologram can be reconstructed in the x-z plane.

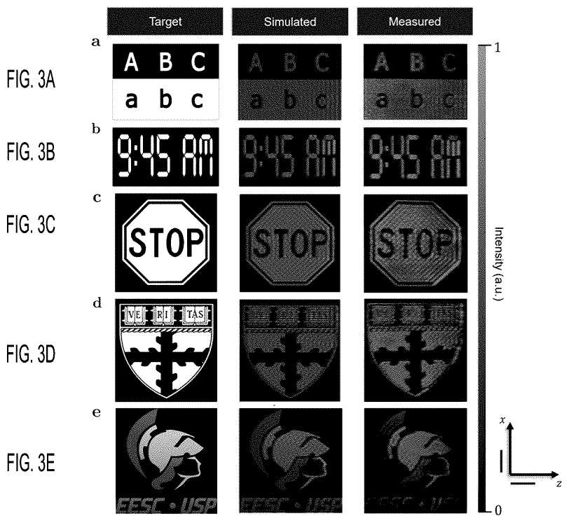

Several patterns of light sheets projected along the direction of propagation can be designed and generated. 2D patterns can be demonstrated. The method can be generalized to create volumetric objects. The holograms can be designed at the visible wavelength (532 nm) and can be projected over a longitudinal range of 55 cm. The holograms can be realized at other wavelengths and dimensions. FIGS. 3A-3E exhibit five different profiles that have been holographically projected in the x-z plane, propagating from left to right in the plane normal to the SLM. In the first example (FIG. 3A), three letters can be projected on dark and bright backgrounds to test the contrast of the output image. Evidently, both the dark background (top) and foreground (bottom), and the sharp boundary in between, can be successfully reconstructed with high fidelity and contrast and without considerable interference between the forward propagating light threads. Likewise, the round curvature and steep corners of the letters can all be well-defined.

Similarly, in FIG. 3B, the dark background region of the digital clock can be effectively realized with almost no residual contributions from the bright components of the image. The smaller features of the image, namely the two dots of the colon “:”, are intact and are in very good agreement with the target and simulated patterns. In FIG. 3C, an example of a “STOP” sign in which the sharp edges and narrow dark lines can all be reconstructed with high resolution across the entire extend of the image. Holograms of this kind can potentially be deployed as dynamic traffic signs in public streets or garages.

More complicated patterns such as the logo of Harvard John A Paulson School of Engineering can be considered as depicted in FIG. 3D. While larger features like the dark cross and overall print of the logo have been nicely constructed, resolving finer features as the “VERITAS” motto can be challenging. A quick comparison between the measured and simulated images reveal that may not be possible to fully resolve these letters even in theory, with the current design parameters. However, this limitation may not be fundamental but rather stems from the choice of a parameter space that can be practically implemented using a SLM (with pixel pitch δx=8 μm).

FIGS. 3A-3E illustrates generation of 2D holographic light sheets. Target image, simulated profile, and reconstructed hologram for three alphabets with dark and bright backgrounds (FIG. 3A), alpha-numerical pattern that mimics a digital alarm clock (FIG. 3B), traffic sign (FIG. 3C), Harvard University logo (FIG. 3D), and University of São Paulo logo (FIG. 3E) are shown in multi-level gray-scale. All images can be projected in the horizontal (x-z) plane, perpendicular to the SLM. Horizontal and vertical scale bars are 10 mm and 0.5 mm (for simulations), and 2.5 mm and 0.125 mm (for measurements), respectively.

The pixel pitch can limit the highest spatial frequency of the Bessel modes that can forward propagate such that max(kᵣ)≤1/δx (where kᵣ is the transverse component of the wavevector). Akin to a Fourier series in which a periodic function can be reconstructed by including higher order sinusoidal terms in the superposition, the quality of each light thread (e.g., each row of the projected image) can depend on the total number of co-propagating Bessel beams in the superposition and their spatial frequencies. In essence, an implementation medium that can offer smaller pixel pitch can allow Bessel modes with larger spatial frequencies to be included, thus resolving all these fine features.

Metasurfaces can be among the most common platforms that can address this limitation given their sub-wavelength pixel pitch, which can easily enable the reconstruction of these holograms with at least 10× its current resolution. Alternatively, the spatial frequencies can be fixed but a larger display can be used to project the logo over a larger area where those tiny features can be resolved. In addition, the reconstructed images can exhibit weak intensity modulation (ripples) in regions where the intensity is supposed to be uniform. This can stem from the underlying superposition of co-propagating Bessel beams in a manner that resembles a (truncated) Fourier series. Smoother intensity profiles can be readily obtained by including more Bessel terms with higher spatial frequency in the sum—a capability that can again be afforded with metasurfaces.

While all four examples discussed so far have considered two-level (binary) intensity images, the systems and methods of the present disclosure can be applied to realize target images with multi-level intensity. This is demonstrated in FIG. 3E in which the logo of University of São Paulo's School of Electrical Engineering is generated. In this case, some features (such as the helmet) have darker/brighter intensity levels compared to other regions of the image, yet are still constructed with high accuracy. Intensity gradients of this kind can be often considered as critical cues for accurate depth perception.

Holographic light sheets can realize many possibilities. The projected image at the y=0 plane and its vicinity (sheet thickness is 60 μm) can be fully controlled. There can be limited control over the intensity profile outside that region. This can suggest that accurate construction of the holograms might (in some cases) can be realized at the expense of undesired residual energy outside the plane of interest.

Monochromatic 2D images along the optical path can be projected. Nevertheless, by superimposing three light sheets, representing the RGB channels, it is possible to generate a full color image. This can potentially be implemented with a holographic medium that can impart three independent phase profiles on the blue, green, and red wavelengths, simultaneously —a capability which can be realized efficiently with dispersion-engineered metasurfaces.

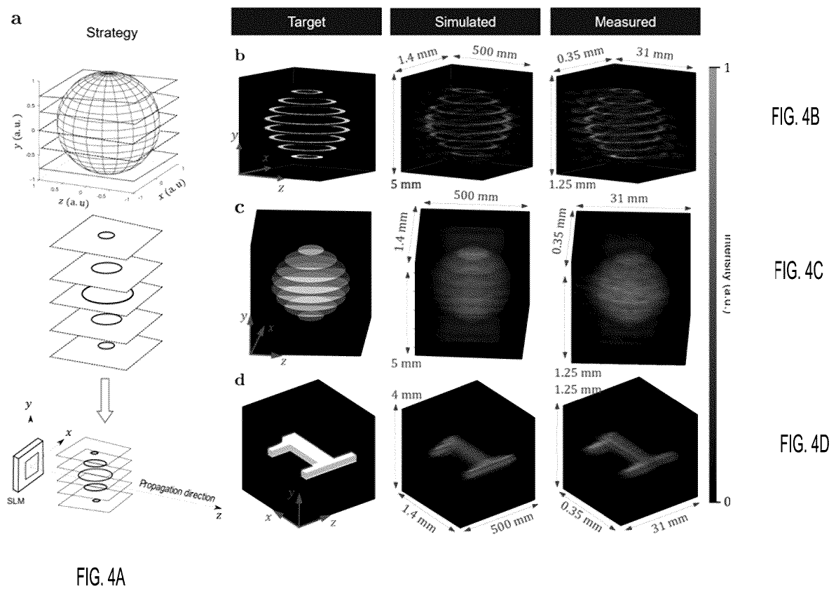

A stack of 2D holographic light sheets, oriented along the optical path, can be adequately cascaded to form a volumetric object. FIG. 4A illustrates this concept in which a target scene is decomposed into parallel planar slices with equal separation in between. Each 2D slice can include forward propagating light threads for which the initial field distribution (at the z=0 plane) can be analytically obtained. The initial field distributions associated with each 2D slice can then be superimposed and transformed into a single computer-generated hologram which can be addressed on an SLM. When illuminated by a quasi-plane wave, the SLM can project all 2D slices, in parallel, thus constructing the target volume.

A number of 3D holograms can be designed and measured. For example, in FIG. 4B, a sphere can include 8 hollow rings, each separated by 0.477 mm, can be generated. The designed pattern can extend for 50 cm in the z-direction and can occupy roughly 0.5 cm in the transverse direction. The sphere can be relatively stretched along the longitudinal direction. This can stem from a choice to operate in the paraxial regime (setting L=55 cm) which can mandate the use of Bessel beams with small cone angles. Nevertheless, the aspect ratio can be adjusted by tuning the parameters of the hologram or by changing the magnification ratio of the 4-ƒ lens system after the SLM. A demagnification ratio of 4:1 can be used. This can scale down the projected hologram by 1/4× and 1/16×, in the transverse and longitudinal directions, respectively. The measured pattern thus can exhibit a more realistic aspect ratio and its spatial profile is in good agreement with simulation, demonstrating the ability of this approach to resolve each ring despite the close inter-spacing. Similarly, in FIG. 4C, a solid sphere that includes 8 bright circles, separated by 0.468 mm, can be projected, realizing a true 3D volume with continuous depth sampling (reconstruction) along the z-direction, uniform sampling in the transverse direction, and with very high contrast of ˜−20 dB.

Furthermore, the systems and methods of the present disclosure can be applied to create volumetric dark regions which often arise due to phase singularities in the optical field. Owing to their steep phase gradients, singular light fields can exhibit interesting super-oscillatory behavior and have thus been utilized in metrology. Additionally, in FIG. 4D, the spacing between the slices can be reduced to about 100 μm to project a volumetric digit “1” which is displayed with minimum background noise. Cross-talk between different layers can be reduced by separating the image planes further apart (albeit on the expense of larger display) or by deploying tricks from signal processing, for example, by adding random phase noise or using machine learning-based optimization.

FIGS. 4A-4D illustrate assembly of 2D holographic light sheets to construct volumetric (3D) scenes. FIG. 4A illustrates that the strategy can rely on discretizing the target scene into 2D slices with small separation in between. Each slice can be decomposed into a number of co-propagating parallel light threads, for which the initial field distribution is calculated. The z=0 field distribution for all 2D light sheets can all be added then transformed into a single computer-generated hologram, addressed onto an SLM. The SLM can then project the 2D stacks to create the desired 3D scene. FIG. 4B illustrates target, simulated and experimental reconstruction of a 3D sphere made of hollow rings. FIG. 4C illustrates generation of a 3D solid sphere. FIG. 4D illustrates reconstruction of a volumetric digit, “1”.

The systems and methods of the present disclosure can be directed to light sheet holography, a new class of holograms which can project the target image along the direction of light's propagation. Unlike Fourier and Fresnel based holography which can discretize a 3D scene along the optical path, inevitably affecting the axial resolution and depth perception, the systems and methods of the present disclosure can allow the desired scene to be reconstructed, continuously, in the axial direction with uniform discretization in the lateral direction. The axial resolution of the scheme can be limited by the pixel pitch of the implementation medium and can potentially reach tenfold the reported values by deploying metasurfaces for wavefront control at the sub-wavelength scale.

The longitudinally oriented holographic light sheets can specifically be favored in applications which mandate high axial resolution and continuous depth, for true-to-life depth perception, and in configurations where the hologram is preferably viewed from the side to avoid direct transmission towards the viewer, reducing eye fatigue. The finite resolution of SLMs can inevitably set a constraint on the viewing angle. However, this limitation (referred to as the space-bandpath product), can be mitigated using clever arrangements of optics around the display to provide the necessary momentum kick. Importantly, due to their attenuation-resistance and self-healing characteristics, the light sheets can be utilized as part of a volumetric display by projecting multi-layered light sheets onto a stack of diffusive or frosted glass plates or through a suspension of micro-scatters to directly view the whole 3D real images, simultaneously. The holograms can, in principle, be viewed over the full 4π solid angle if used in volumetric displays.

The systems and methods of the present disclosure can be directed to a systematic approach which enables the projection of any 2D image or 3D scene onto light sheets with high fidelity and contrast. The design strategy can be based on non-iterative analytic closed form expressions with calculable computation time. Being composed of forward propagating Bessel modes, the holograms can be scaled to any dimensions and wavelengths, following the same design considerations of axicons. The dimensions of the holographic light sheets can be scaled in size; both digitally by tuning the parameters of the CGH and optically by changing the 4-ƒ lens configuration after the SLM. The scalar light sheets can have the same polarization state. Bessel modes of different polarization can be incorporated to create 3D scenes with spatially varying polarization. In this regard, the 2D sheet can be woven from light threads of alternating orthogonal polarizations to minimize the interference between adjacent light threads. Lastly, besides using programmable SLMs, dynamic control of the holographic sheets can readily be achieved using active metasurfaces, or using OAM metasurface holography in which real-time switching between the holographic scenes is enabled by changing the spatial structure of the incident beam. This class of holograms can inspire new applications in wearable devices, volumetric displays, light sheet microscopy, and other emerging applications.

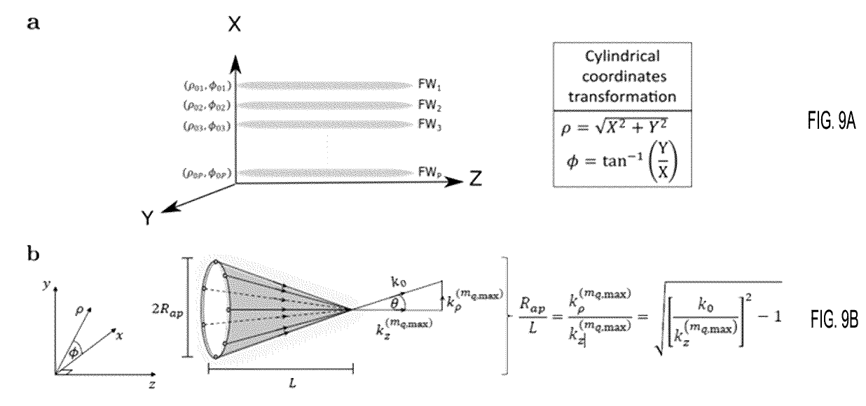

The fabric of the holograms can include a 2D light sheet that includes an array of light threads. A pictorial visualization of a 2D light sheet (or a Surface Frozen Wave) and its decomposition into light threads is shown in FIG. 9. Each thread (e.g., Frozen Wave) can include a discrete superposition of co-propagating zeroth-order Bessel beams with different wavevectors. Due to the constructive and destructive interference among these co-propagating modes, the intensity of the resulting waveform can be modulated with propagation in space. The choice of Bessel beams as the co-propagating modes can be advantageous for the following reasons. Firstly, they possess self-healing and non-diffracting properties which keeps the central spot of the beam intact for a long distance even in the presence of obstruction, and secondly, being an exact solution to the wave equation, they allow a complete analytical description of the field. Therefore, an array of P Frozen Waves (P being the number of FWs) can construct a Surface Frozen Wave which in cylindrical coordinates can be represented as the Fourier series:

$$ψ ( ρ , ϕ , z , t ) = {e}^{- i ω t} {\sum }_{q = 1}^{P} {\sum }_{{m}_{g} = - N}^{N} {A}^{( {m}_{q} )} {J}_{0} ( {k}_{p}^{{m}_{q} )} \sqrt{{ρ}^{2} + {{ρ}_{0}}_{q} - 2 ρ {ρ}_{{0}_{q}} cos ( ϕ - {ϕ}_{{0}_{q}} )} ) {e}^{{ik}_{z}^{{( {m}_{q} )}_{z}}} \qquad ( 1 )$$

The J₀ term denotes a zeroth-order Bessel mode propagating along the z-direction, whereas kₚ^{(m}^{_{q}}⁾ and k_{z}^{(m}^{_{q}}⁾ are the transverse and longitudinal wavevectors, respectively, (kₚ^{(m}^{_{q}}⁾)²+(k_{z}^{(m}^{_{q}}⁾)²=(ω/c)². Here, m_{q} is the index of each Bessel beam in the superposition, ω is the angular frequency, and t is time. Each individual Frozen Wave can be positioned at (ρ₀_{_{q}}, ϕ₀_{_{g}}), and its Bessel mode components can each be weighted by a different complex coefficient A^{(m}^{_{q}}⁾. The longitudinal wavevectors can be chosen according to their corresponding Bessel mode,

$${k}_{z}^{( {m}_{q} )} = Q + \frac{2 π {m}_{q}}{L} \qquad ( 2 )$$

where Q is the central longitudinal wavevector chosen based on experimental parameters, and L is the desired longitudinal length of the target image (e.g., z<L).

The longitudinal intensity pattern of each and every light thread can be designed to follow any arbitrary profile—denoted as F_{q}(z)—by properly selecting the complex coefficient through a Fourier integral:

$${A}^{( {m}_{q} )} = \frac{1}{L} {\int }_{0}^{L} {F}_{q} ( z ) {e}^{- i \frac{2 π}{L} {m}_{q} z} dz \qquad ( 3 )$$

Therefore, the intensity profile of the light sheet can be designed to represent any arbitrary 2D profile along the direction of propagation. The complex coefficients A^{(m}^{_{q}}⁾ can be substituted in Eq. (1) to evaluate ψ which locally approximates the desired response, F_{q}(z). In essence, a wavefront shaping medium that takes the form ψ(ρ, ϕ, z=0, t) at an initial z-plane, transverse to the longitudinal direction, can be able to recreate the desired field distribution at each consecutive z-plane thereafter to display the 2D field in the x-z plane. Bessel beams can contain an infinite number of outer rings (with infinite energy), therefore Bessel-Gauss beams (with finite energy) can be used Eq. (1) to generate the CGHs over a finite aperture.

The measurements can be obtained using a 532 nm laser source (e.g., Novanta Photonics, Ventus Solid State CW laser). The beam can be expanded and collimated by focusing it with an objective lens (40×) through a 50 μm pinhole followed by a 50 cm lens. The collimated beam can be directed onto a reflective SLM (e.g., Santec SLM-200, 1920×1200 resolution, and 8 μm pixel pitch), encoding the desired phase-only hologram onto the beam. A 4-ƒ lens system can be placed after the SLM to filter the desired pattern in the k-space from on-axis (zeroth-order) noise, and to image the beam onto a CCD camera after demagnifying it by a factor of 4×. The CCD camera (Thorlabs DCU224C, 1280×1024 resolution) can be mounted on an automated translational z-stage (Thorlabs LTS150) to record the 2D and 3D holographic images along the propagation direction. The transverse profiles can be recorded at each z-plane with increments of 0.25 mm along the propagation direction. From each recorded image, a ID slice (at the location of the light sheet) can be extracted. These ID slices can be concatenated in the longitudinal direction to reconstruct the final 2D and 3D holographic scenes. The contrast in the holograms can be obtained from the CCD intensity measurements/, and can be defined as

$${log}_{10} \frac{{I}_{min}}{{I}_{max}} .$$

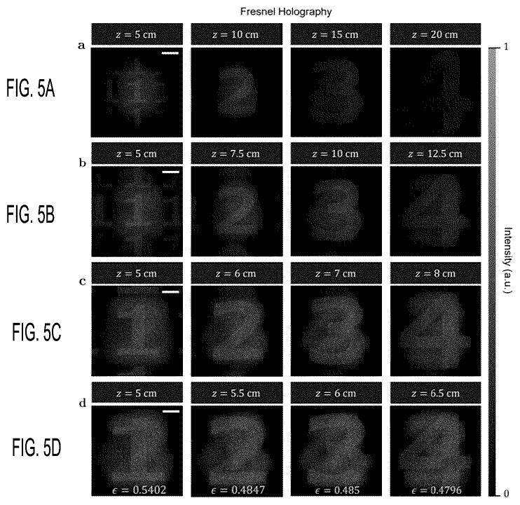

FIGS. 5A-5D illustrates projection of 2D images with Fresnel holography. Four digits “1 2 3 4” are projected along the propagation direction. The longitudinal separation between the image planes is 5 cm (FIG. 5A), 2.5 cm (FIG. 5B), 1 cm (FIG. 5C), and 0.5 cm (FIG. 5D). The scale bars in FIGS. 5A-5D are 2 mm, 1.5 mm, 1 mm and 0.8 mm, respectively. While cross-talk can be reduced by placing the images further apart (FIG. 5A), the size of the displayed images can vary significantly (e.g., becoming larger) at longer propagation distances. This magnification can be mitigated by reducing the separation between the images, however, on the expense of more significant cross-talk (FIG. 5D).

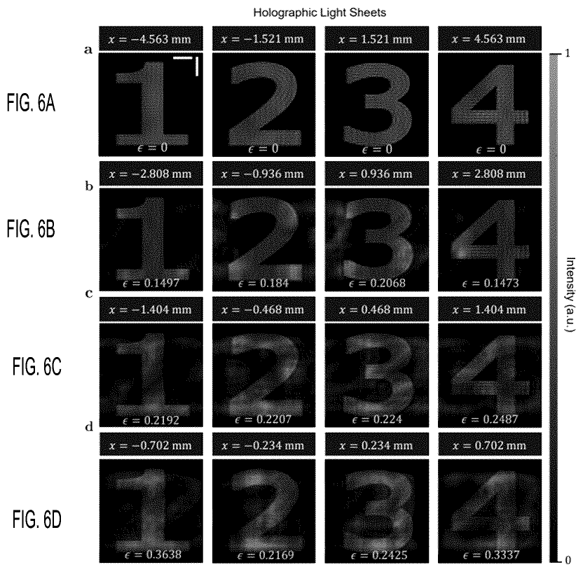

FIGS. 6A-6D illustrate projection of 2D images with holographic light sheets. Four digits “1 2 3 4” are projected in the lateral direction perpendicular to the display. The lateral separation between the images is 3.042 mm (FIG. 6A), 1.872 mm (FIG. 6B), 0.936 mm (FIG. 6C), and 0.468 mm (FIG. 6D). The horizontal and vertical scale bars are 10 mm and 0.5 mm, respectively. Here, cross-talk (signified by ϵ) can be reduced by placing the images further apart in the lateral direction without affecting the size of the projected images.

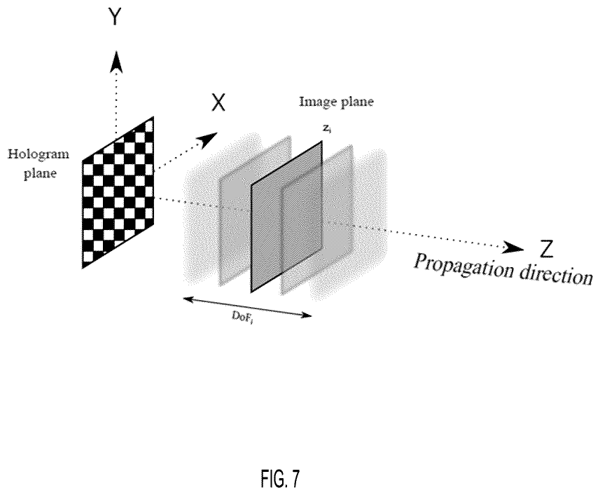

Fresnel-based multi-plane holography can enable reconstruction of 3D objects by stacking multiple 2D images parallel to the display. This approach can provide a good compromise between gradient-based iterative methods, which can be computationally expensive for large number of planes, and semi-analytical non-iterative approaches which can achieve low computational cost on the expense of accuracy such as the point cloud, look-up table, and wavefront recording methods. However, with Fresnel holography, the spacing between consecutive image planes along the optical path cannot be arbitrarily chosen. The depth of field (DoF) can be used as a metric to characterize the axial resolution of each individual image plane, as illustrated in FIG. 7.

FIG. 7 illustrates the Depth of field (DoFᵢ) for an image plane. An image can be projected at the plane z=zᵢ in front of the hologram plane. As incrementally shifted away from the plane z=zᵢ, the projected image can gradually defocus. Any neighboring image plane placed within the DoFᵢ can be severely affected by crosstalk or interference from this defocused residue.

In the Fresnel regime, DoF at an image plane i can be expressed as

$$DoF ∝ {λ [ \frac{1}{{n}_{h}} \frac{{z}_{i}}{d ξ} ]}^{2} , \qquad ( 4 )$$

where nₕ×nₕ is the resolution of the Fresnel hologram, zᵢ is the distance at which the image is projected from the hologram plane, λ is the wavelength, and dξ is the pixel size of the display.

The product nₕdξ in the denominator can be equivalent to the aperture size. In a given imaging system the ratio between the focal length and the aperture diameter, akin to Eq. 4, can be known as the ƒ-number, given by

$$f = \frac{{z}_{i}}{D}$$

and it provides a measure of the amount of light entering the imaging system through an iris. In essence, reducing the aperture size can increase the f-number and DoF. The ƒ-number can be inversely proportional to the numerical aperture

$$NA ( NA \approx \frac{nD}{2 {z}_{i}} nD or f \approx \frac{1}{2 NA} ,$$

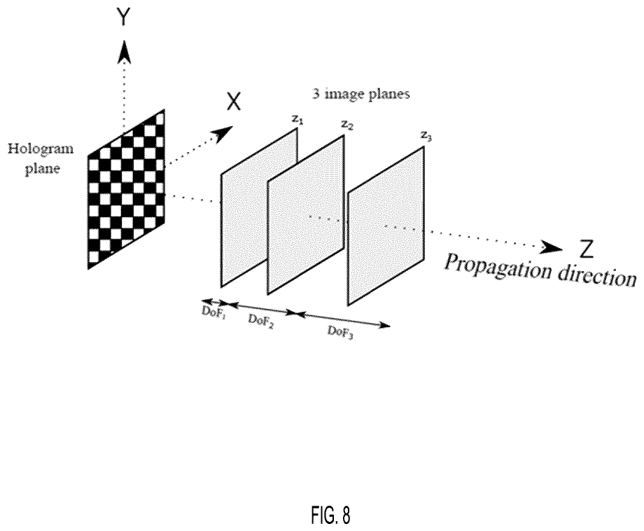

n is the medium's refractive index 8). Given that the physical size and numerical aperture of a holographic display can be finite, then any Fresnel based holographic image can be projected with an extended DoF which scales up with the focal length zᵢ. To construct a realistic 3D scene, the crosstalk (or interference) between the projected images can be minimized. Notably, any overlap between DoFs of two neighboring image planes can be detrimental to the quality of the projected image. From Eq. 4, the DOF can scale quadratically with zᵢ. Therefore, images placed further away from the hologram plane can have larger inter-plane spacing compared to images closer to the hologram plane to eliminate cross talk. This can lead to a non-uniform sampling of the 3D scene in the axial direction, as illustrated through a 3-plane example in FIG. 8 affecting the reconstructed scene's quality and depth perception.

FIG. 8 illustrates unequal separation for multi-plane projection. Three images can be projected at z₁, z₂ and z₃ distance away from the hologram to eliminate any overlap between their DoFs. Due to DoF's dependence on the propagation distance, the inter-plane distance between the images can be unequal, hindering realistic 3D projection and depth perception.

The 2D designs shown in FIGS. 3A-3E can be reconstructed using 532 nm (A) light beam including 80 Frozen Waves (P=80) extending for 55 cm (L) in the propagation direction. FIG. 3A can be reconstructed with L=54 cm due to optimization constraints. The chosen Frozen Wave spot size (r0=30 μm) can roughly be considered equal to the spot size of central Bessel mode (e.g., m_{q}=0). In turn, this predetermines the longitudinal wavevector associated with the central Bessel mode which is given by:

$$Q = k [ 1 - \frac{1}{2} {( \frac{2.4048}{{r}_{0} k} )}^{2} ] = 0.999977 k , \qquad ( ( 5 )$$

where k=2π/λ. The large Q/k value can ensure that this is operating in the paraxial regime. This can be a necessary condition for the light beam to propagate and display the desired pattern over a large distance L with negligible contributions from its longitudinal field component.

Adding to that, non-evanescent forward propagating beams in each Frozen Wave can be required. This condition can set an upper limit for allowed values of longitudinal wavevectors,

$$0 < Q + \frac{2 π {m}_{q}}{L} \leq k .$$

Subsequently, the largest allowed value for m_{q} can be,

$${m}_{q , m a x} = ⌊ \frac{L}{2 π} ( k - Q ) ⌋ = 47 , \qquad ( ( 6 )$$

where └ ┘ denote floor rounding. Therefore, each Frozen Wave can include 95 (2m_{q,max}+1) Bessel modes with longitudinal wavevectors centered at a value of 0.999977 k.

The resolution of the holographic display can set another constraint on the choice of Bessel modes. For instance, to construct the target image with high fidelity, the SLM (or any phase mask) should be able to sample the highest transverse spatial frequency in the image; max(k_{ρ})≤1/δx (where k_{ρ} and δx are the transverse component of the wavevector and the pixel pitch, respectively). A phase-only reflective SLM (Santec SLM-200) with 1920×1200 pixel resolution and 8 μm pixel pitch can be used. The dimensions of the SLM can play a role in determining the parameters for the designs, particularly L and P. An aperture of infinite size can generate multiple copies of the output waveform along the propagation direction due to the Fourier-like series underlying Bessel beam superposition. On the other hand, when the aperture is not large enough, the waveform can be truncated in the axial direction. Therefore, the phase-only field addressed on the SLM can fit the appropriate aperture size (1.54 cm×0.96 cm). This can be reconciled by visualizing each Bessel beam mode in terms of plane waves propagating through axicons of different cone angles. The Bessel mode with the largest axicon angle (m_{q}=−m_{q,max}) can determine the minimum aperture radius needed to generate a single Frozen Wave over a propagation range, L. The aperture radius can be given by:

$${R}_{ap} = L \sqrt{{[ \frac{{k}_{0}}{{k}_{z}^{( {m}_{q , m a x} )}} ]}^{2} - 1} . \qquad ( ( 7 )$$

This can be derived from the geometric argument of axicons in which k_{z}^{(m}^{_{q}}⁾ and kₚ^{(m}^{_{q}}⁾ lie on the sides of a right angle triangle (e.g., along the z and the radial directions, respectively) such that

$$\frac{{R}_{ap}}{L} = \frac{{k}_{ρ}^{( {m}_{q , m a x} )}}{{k}_{z}^{( {m}_{q , m a x} )}} ,$$

as depicted in FIG. 9.

FIGS. 9A and 9B illustrate decomposition of a Surface Frozen Wave. FIG. 9A illustrates that the light sheet can include P Frozen Waves propagating in the z direction, each laterally offset with equal separation in the x-direction. The corresponding location of each Frozen Wave in the cylindrical coordinates can be retrieved by using a suitable transformation. FIG. 9B illustrates that each Frozen Wave can include a series of Bessel beams. A Bessel beam can be created from an axicon. Its longitudinal and transverse wavenumbers, k_{z}^{(m}^{_{q}}^{,max)} and k_{ρ}^{(m}^{_{q}}^{,max)}, can be geometrically viewed as the sides of a right-angle triangle and are proportional to the depth of field (L) and the aperture size (Rₐₚ), respectively.

Without loss of generality, the Frozen Waves array can be placed along an arbitrary x-axis and the minimum rectangular aperture (Lₓ, min×L_{y},min) required at the hologram plane can be calculated, such that:

$${L}_{x , m i n} = 2 {R}_{ap} + \vert {x}_{1} - {x}_{80} \vert \approx 1.4 cm , \qquad ( ( 8 )$$

$$and$$

$${L}_{y , m i n} = 2 {R}_{ap} \approx 1.05 cm$$

where x₁ and x₈₀ represent the x-coordinate of the first and last Frozen Wave in the array included in holographic sheet, respectively. The parameter values selected in the design can be chosen to ensure that the required aperture size is compatible with the SLM dimensions.

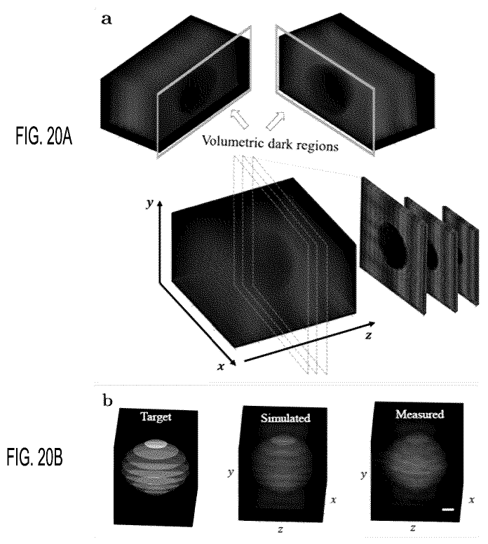

The number of Frozen Waves can be decreased to P=30 in each image stack while keeping all other parameters unchanged. The spacing between the image stacks can be chosen considering two factors: minimizing interference between nearby image stacks and ensuring that the required wavefront at the hologram plane fits the SLM aperture (1.54 cm×0.96 cm). The consequence of the latter condition can lead to the choice of a specific value for P. This constraint can be relaxed using a larger display. The spacing values in FIGS. 4B, 4C, 4D, and 4E can be roughly 0.477 mm, 0.468 mm, 0.108 mm and 0.468 mm, respectively. The value 0.108 can be the average spacing between the image stacks (6 image stacks placed within a distance of 0.54 mm). The actual spacing can vary between different image stacks and can be qualitatively chosen based on the visual quality of simulated 3D volume. Also, the same parameter values for the 3D sphere of light, shown in FIG. 20, can be used.

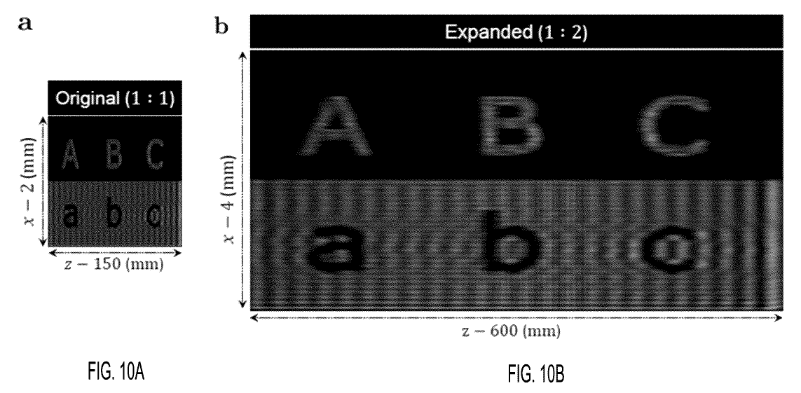

In principle, the size of the display can set an upper limit on the dimensions of the projected hologram. Nevertheless, it is possible to relax this constraint and project the desired hologram onto a larger or smaller area—or volume, for the case of 3D—by making use of suitable optical configurations. For instance, the 4-ƒ lens system after the SLM can be used to magnify (or demagnify) the hologram, on demand, by merely changing the focal length of its two lenses (FIG. 2D). This can allow scaling both the transverse and longitudinal dimensions of the displayed scene. Notably, demagnifying the 2D transverse profile (uploaded on the display) by a factor of M can lead to compressing the reconstructed pattern along the longitudinal direction by a factor of M². On the other hand, magnifying the transverse profile of the hologram can stretch it along the propagation direction, quadratically. Hence, the scaling of the transverse and longitudinal dimensions can follow linear and quadratic dependence on M, respectively, further enabling the adjustment of the aspect ratio of the projected hologram by tuning the parameter M. M can be set to 1/4, hence, the generated patterns can be 16 times shorter in the z-direction compared to the simulated data (which in turn were evaluated for M=1). This concept is further illustrated in FIGS. 10A and 10B. The constructed profile of the target hologram can be depicted in FIG. 10A with no magnification, assuming the focal lengths of the 4-ƒ lens system follow 1:1 ratio. By changing the magnification ratio to 1:2 (for instance using ƒ₁=10 cm and ƒ₂=20 cm), without changing the SLM display, the constructed pattern can be magnified by a factor of two in the transverse direction and can stretch four times along the propagation direction as shown in FIG. 10B.

FIGS. 10A and 10B illustrate scaling of the projected hologram. The displayed hologram can be scaled in size on demand via the 4-ƒ lens configuration after the SLM. FIG. 10A illustrates the original hologram without magnification. Here, the 4-ƒ lens system can include two lenses with the same focal length. FIG. 10B illustrates the magnified hologram in which the target pattern stretches over 4 mm and 600 mm along the transverse and longitudinal directions, respectively. Here, the focal lengths of the two lenses can be ƒ₁=10 cm and ƒ₂=20 cm. This can lead to a magnification of (2×) in the transverse direction and (4×) in the longitudinal direction.

In addition to tuning the parameter M, the aspect ratio can be adjusted by designing the cone angles of the Bessel beams that generate the hologram. The longitudinal intensity modulation in the envelope of the surface Frozen Wave can arise from interfering co-propagating Bessel beams by the virtue of their different k-vectors (spatial frequencies), reminiscent of a Fourier series, thereby constructing each structured light sheet. This can be similar to synthesizing a square wave by adding a large number of sinusoidal waveforms. The SLM resolution (pixel pitch) can set an upper limit on the number of co-propagating Bessel beams in the superposition. For example, only Bessel beams with spatial frequencies that can be sampled by the SLM screen (without violating Nyquist criteria) can be readily supported. The separation between the longitudinal wavenumbers (given by 2π/L) can dictate the modulation window of the output waveform along the propagation direction, denoted by the distance L, which can also specify the depth of field. Within that region, L, each holographic light sheet can be structured on demand while remaining diffraction-free and without z-dependent (de)focusing.

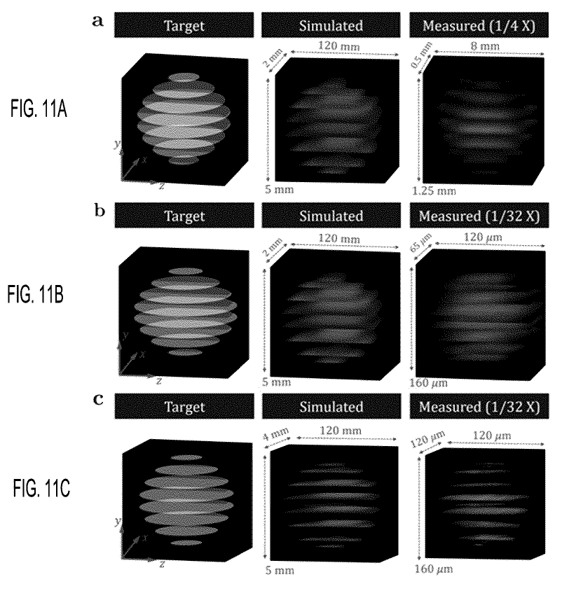

Additionally, the absolute value of the wavenumbers can govern how abruptly the envelope can be modulated within that space region, L. To modulate the intensity over very short distances along z-direction (with high resolution), the holographic display can implement Bessel functions with a wide range of small and large spatial frequencies. As a rule of thumb, the smallest interval within which the pattern can be structured (switched on and off) along the z-direction can be inversely proportional to the spectral width of the ensemble in k_{z}-space and is roughly ≈L/(4πN). Various profiles of longitudinally varying intensity can be realized provided that the spatial harmonics in the sum can adequately synthesize the ensemble. Therefore to obtain holographic reconstruction of a target object with proper aspect ratio, L can be set to short distance and a high resolution holographic display that can support high spatial frequencies can be used. To demonstrate this, the 3D sphere, shown in FIG. 4C, can be projected over a shorter propagation distance by setting L to 12.5 cm (instead of 55 cm). The 4-ƒ demagnification ratio can be kept the same (M=1/4). The target sphere can be displayed over 8 mm in the z-direction, thus reducing the aspect ratio as depicted in FIG. 11A.

Notably, by changing the demagnification ratio to M=1/32, a more realistic aspect ratio can be realized for the sphere as a result of compressing the axial dimension, as shown in FIG. 11B. In this case, every 2D light sheet can include 30 Frozen Waves, each separated by 22.5 μm. By extending the width of each sheet—either by stacking more Frozen Waves in the array or increasing the spacing between the Frozen Waves—the lateral dimensions of each sheet can be stretched to reach an almost uniform (1:1:1) aspect ratio. This is demonstrated in FIG. 11C where the spacing between the Frozen Waves in each sheet can be increased from 22.5 μm to 45 μm, thus extending each sheet in the x-direction by a factor of 2. Notably, constructing a 3D object with 1:1 aspect ratio can mandate the use Bessel beams with large cone angles, thus deviating from the paraxial regime. As the cone angles get larger (in simulation by changing the values of the k vectors and in experiment using 4-ƒ lens system with large demagnification) the longitudinal field components (E_{z}) shall no longer be neglected. The contribution of E_{z} in addition to higher order Bessel terms can arise as the non-paraxial regime is approached (to satisfy the exact Maxwell's equations). This can lead to a slight degradation in the quality of the constructed image as observed. Furthermore, the interference between the adjacent Frozen Waves can affect the quality. These effects can be collectively mitigated using Frozen Waves with alternating polarization and by adopting the non-paraxial formulation.

The sheets can be further scaled down using Bessel beams with higher spatial frequencies. Owing to their sub-wavelength resolution (420 nm in the visible range), metasurfaces can sample the transverse profile of the highest-frequency Bessel function, up to

$${k}_{p} \leq \frac{1}{2 \times 420 nm} ,$$

without violating Nyquist's criterion—offering a tenfold improvement on the results, which relied on an 8 μm pixel pitch. Furthermore, with a larger display, the pattern can be re-scaled in the lateral direction to tune the aspect ratio. A larger display can also allow for stacking the sheets with larger separation in between, thus reducing the coherent trace of one sheet onto the other. Moreover, higher resolution can allow for stacking more localized Frozen Waves with smaller features, hence improving the lateral resolution of the displayed pattern. Lastly, longer depth of field (L) can allow operation in the paraxial regime, reducing the interference between the adjacent Bessel beams in each light sheet. This is because paraxial Frozen Waves can switch on/off their center spot (modulate their envelope) by dispersing the energy to the outer rings over larger radius (and lower intensity), thus reducing the interference between adjacent Bessel beams compared to the non-paraxial case.

FIGS. 11A-11C illustrate projection of 3D spheres with improved aspect ratio using holographic light sheets. The solid sphere can include 8 equally-spaced layers of light sheets extending along the z-direction. The simulated sphere can extend over 120 mm in the axial direction (middle column). The aspect ratio of the sphere can be adjusted using a 4-ƒ system with 4:1 demagnification (FIG. 11A), 32:1 demagnification (FIG. 11B), or 32:1 demagnification (FIG. 11C) while extending the width of each sheet in x-direction, thus providing a more realistic aspect ratio.

The scalar and paraxial formulation can be used to construct the surface Frozen Waves. This formulation can be valid as long as the longitudinal wavevectors (k_{z}) are much larger (≥100×) than the transverse wavevectors (k_{ρ}). In this regime, the dimensions of the surface Frozen Waves can be scaled using a 4-ƒ lens system. However, under tight focusing (for e.g., ≤1/50 ×), the longitudinal component of the electric field (E_{z}) can become significant and can no longer be neglected. In this case, the scalar formulation of Frozen Waves can break down and the full vectorial (non-paraxial) nature of the field can be considered. Non-diffracting beams can be structured in the axial direction, on demand, over length scales a few times larger than the wavelength. The concept can rely on including a continuous (rather than discrete) superposition of non-diffracting beams to construct each Frozen Wave. This formulation can be used to synthesize a 3D holographic sphere with a perfect (1:1:1) aspect ratio. The 3D solid sphere can be constructed from an array of 15×15 non-paraxial Frozen Waves (FWs) at 532 nm wavelength. Each FW can have a spot size of 0.75 μm. The distance between the FWs in each sheet can be 7.5 μm, center-to-center. Alternate orthogonal linear polarization (oriented along x and y) can be used for the FWs in each array to reduce their interference. Figure S6 depicts the synthesized hologram, which can extend for 52.5 μm in the propagation direction (z-axis). Here, the radius of the sphere can be set to be 26.25 μm, achieving a uniform aspect ratio. A profile of this kind can be realized with a high-resolution phase mask, such as a metasurface, or using SLMs with a clever arrangement of optics to (de)magnify the hologram before and after the SLM.

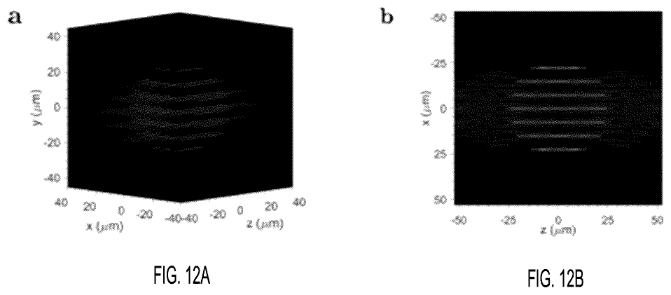

FIGS. 12A and 12B illustrates a non-paraxial 3D sphere. FIG. 12A illustrates reconstruction of a 3D solid sphere using an array of 15×15 continuous Frozen Waves with spot size 0.75 μm, each separated by 7.5 μm. Alternate orthogonal linear polarization can be for each FW. FIG. 12B illustrates the same pattern projected in the x-z plane.

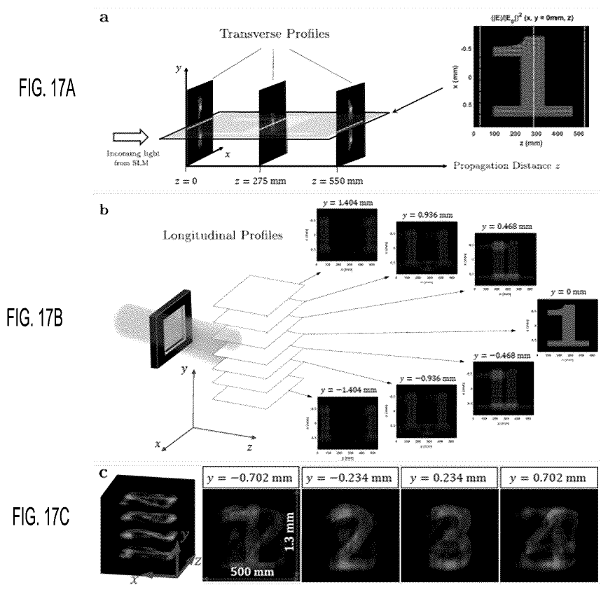

Under some circumstances, the quality of the reconstructed 3D holograms may suffer from unwanted interference effects as a result of the tight separation between the projected images (see, for example, FIG. 17C). The number of Frozen Waves in the array can play a role in the reconstruction quality of the light sheets as it can affect the pixelation of the generated image in the x (or y) direction. The choice of parameters can be influenced by the specifications of a commercial SLM (e.g., Santec, SLM-200). If the constraints imposed by such a device, namely its limited aperture size and resolution, are lifted, then the image quality can be significantly enhanced by choosing another set of parameters that mitigates the inter-plane cross talk.

Several directions can be pursued to realize higher reconstruction quality. First, cross-polarization can be introduced between adjacent Frozen Waves to minimize unwanted interference. In this case, alternating Frozen Waves can be x-linear and y-linear polarized to eliminate undesired interference between neighboring light threads. These vectorial light sheets can be generated using metasurfaces with form birefringent meta-atoms to structure the polarization, point-by-point, at the target image. Second, the number of adjacent Frozen Waves in the light-sheet can be increased to enhance the image resolution, allowing the target scene to be sampled with larger number of pixels.

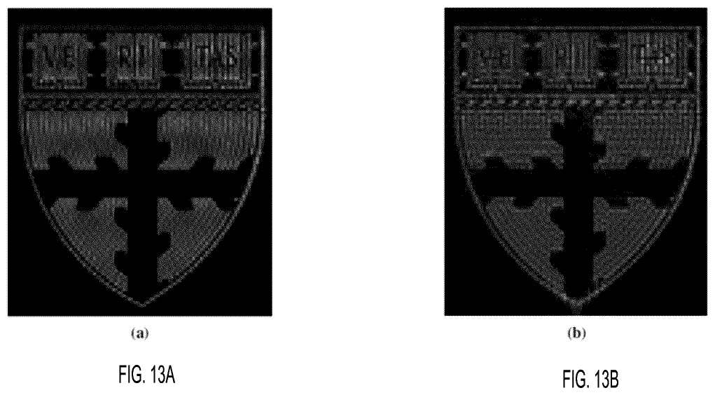

As a proof of concept, the reconstructed logo of Harvard SEAS (FIG. 3D) can be revisited. A different hologram can be designed after lifting the SLM constraints. The simulated images can show qualitative improvements, as seen in FIGS. 13A and 13B. This can become pronounced in observing the finer features of the image, such as the “VERITAS” motto. In both images, the resolution of the motto can be better compared to the measured result. For both simulations, a 532 nm (λ) light beam including 160 Frozen Waves (P) extending 100 cm (L) in the propagation direction can be used. The transverse spot size of each individual Frozen Wave can be fixed at 30 μm. This can be reconciled as displaying the hologram over a larger area to better resolve its fine features. The difference between these two cases can lie in the inter-Frozen Wave spacing and input polarization of light. In FIG. 13A, all Frozen Waves can be linearly polarized in the x-direction, and the Frozen Waves separation can be 45 μm. While in FIG. 13B, alternate Frozen Waves can be x- and y-polarized, respectively, and the Frozen Waves separation can be reduced to 30 μm. Lastly, the holographic sheets may be not limited to free space propagation but can apply to propagation in a medium characterized by complex refractive index. This can rely on judiciously designing the coefficients the Bessel beams within each Frozen Wave, allowing the envelope to compensate for propagation loss through an energy exchange between the target sheet and its surrounding region.

FIGS. 13A and 13B illustrate improvements in reconstruction quality. The Harvard SEAS logos can be generated using N=160 Frozen Waves with 45 μm separation and linearly polarized light in x-direction (FIG. 13A) and 30 μm separation and alternate orthogonal linear polarization (x and y) (FIG. 13B).

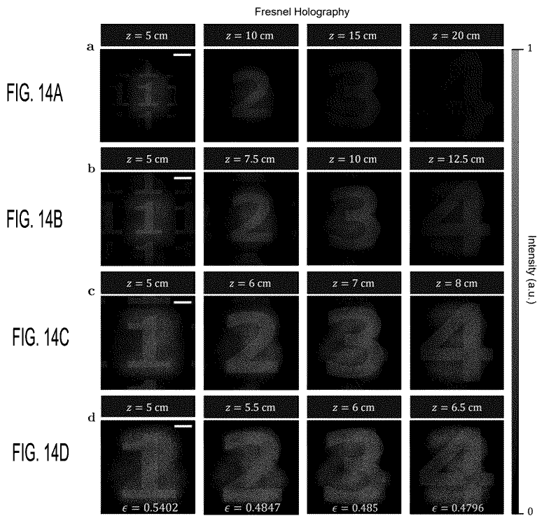

To evaluate the reconstruction quality of the holographic light sheets, quantitative comparison with methods that make use of propagation in the Fresnel regime can be performed. The latter can rely on stacking multiple 2D images parallel to the display. FIGS. 14A-14D depict the case of displaying four numerical digits “1 2 3 4” along the propagation direction, z, using Fresnel holography. The spacing between the images can play a role in defining the image quality. For instance, when the images are projected further apart, with longitudinal spacing of 5 cm, one can observe that each digit is reconstructed with relatively low cross-talk (FIG. 14A). Since each image can be essentially weighted by a parabolic lens profile with different numerical aperture the size of projection can increase further away from the display as seen in the same figure. A more uniform scaling can be attained by reducing the longitudinal separation between the images albeit on the expense of stronger cross talk as illustrated in FIGS. 14B-14D. Here, the cross-talk can arise from the finite depth of field of each image which can cause each image to print a coherent trace of itself onto its adjacent planes.

FIGS. 14A-14D illustrate projection of 2D images with Fresnel holography. Four digits “1 2 3 4” are projected along the propagation direction. The longitudinal separation between the image planes is 5 cm (FIG. 14A), 2.5 cm (FIG. 14B), 1 cm (FIG. 14), and 0.5 cm (FIG. 14). The scale bars in FIGS. 14A-14D are 2 mm, 1.5 mm, 1 mm and 0.8 mm, respectively. While cross-talk can be reduced by placing the images further apart (FIG. 14A), the size of the displayed images vary significantly (becoming larger) at longer propagation distances. This magnification can be mitigated by reducing the separation between the images, however, on the expense of more significant cross-talk (FIG. 14D).

To quantify the effect of this interference on the projection quality, the reconstruction error e can be evaluated as follows:

$$ϵ = \frac{{Σ}_{i , j} ( \vert {I}_{i , j}^{n} \vert - \vert {I}_{i , j}^{ref} \vert )}{{Σ}_{i , j} ( \vert {I}_{i , j}^{n} \vert + \vert {I}_{i , j}^{ref} \vert )} \qquad ( ( 9 )$$

Here, |I_{i,j}ⁿ|, refers to the normalized intensity at pixel (i, j) of the projected hologram, whereas |I_{i,j}^{ref}| denotes the normalized intensity of a reference hologram that is an exact copy of |I_{i,j}ⁿ| but with zero cross-talk. The latter can be reconciled as a single-plane hologram, projecting only the target image while keeping all the other images in the adjacent planes switched off, naturally eliminating cross-talk. Equation 9 therefore suggests that, for each target image, the error between the reconstructed image (obtained from the multi-plane projection) can be evaluated and compared with the ideal target image (from a single-plane hologram). Hence, any non-zero error (that arises between the two images can be attributed to cross-talk. FIG. 14D depicts the Fresnel based four-plane projection of digits “1 2 3 4”, each separated by 1 cm, where ϵ acquires a mean value of 0.4974 suggesting relatively strong interference.

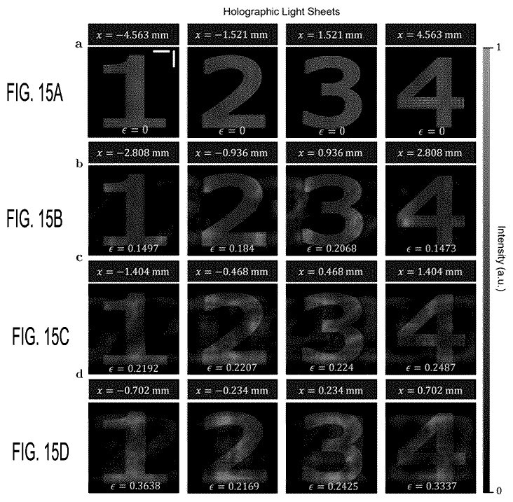

To complement FIGS. 14A-14D, the four-plane projection of the digits “1 2 3 4” can be studied using the holographic light sheets. FIGS. 15A-15D depict the case of projecting these target images at four adjacent planes, oriented perpendicular to the display, with variable separation in between. A separation of 3 mm can be sufficient to eliminate any coherent trace of one image onto the others (FIG. 15A). As the separation becomes closer the cross-talk ϵ can become more significant. Even at a separation of 450 μm (FIG. 15D) the mean value of ϵ is 0.2892 which is still better than the case of Fresnel holography at ten times the spacing value (FIG. 14D).

FIGS. 15A-15D illustrate projection of 2D images with holographic light sheets. Four digits “1 2 3 4” are projected in the lateral direction perpendicular to the display. The lateral separation between the images is 3.042 mm (FIG. 15A), 1.872 mm (FIG. 15B), 0.936 mm (FIG. 15), and 0.468 mm (FIG. 15D). The horizontal and vertical scale bars are 10 mm and 0.5 mm, respectively. Here, cross-talk (signified by ϵ) can be reduced by placing the images further apart in the lateral direction without affecting the size of the projected images.

The potential of adding random phase to reduce cross-talk can be studied. However, adding random phase can be effective in the limit of very large number of pixels (>1000) to operate in the regime of the central limit theorem and law of large numbers. In the patterns, each sheet can be discretized into an array of lines or voxels (e.g., Frozen Waves (FWs)) which in turn can be interpreted as the pixels of the patterns. Given the choice of small number of FWs in each sheet (˜80), adding a random phase noise may not help eliminate the cross-talk. At the same time, incorporating a very large number of FWs (˜1000) to make use of random noise may not be computationally feasible. Lastly, random phase noise can be associated with undesired (grainy) features that affect the image quality—a behavior that can be avoided in the holograms.

The field distribution can be given by ψ(ρ, ϕ, z=0, t)—a 2D complex (amplitude and phase) field which constructs the target scene upon propagation (Eq. (2)). Without loss of generality, ψ(ρ, ϕ, z=0, t) can be given by the amplitude and phase term such that: ψ=a(x, y)e^{iΦ(x,y)}, where the amplitude a(x, y) can vary in the interval [−1, 1], and the phase Φ(x, y) lies within [−π, π]. To be compatible with the phase-only SLM, the profile ψ can be converted to a unitary computer-generated hologram. The latter can be cast in the form:

$$h ( x , y ) = {e}^{i Θ ( a , Φ )} , \qquad ( ( 10 )$$

where Θ(a, Φ) is the hologram modulation and is expressed as a function of the amplitude and phase of the target profile. Here, the spatial dependent on x and y can be omitted for clarity.

The hologram function h(x, y) can be represented as a Fourier series in the domain Φ such that h(x, y)=Σ_{q=-∞}^{∞}h_{q}(x, y), where:

$${h}_{q} ( x , y ) = {C}_{q}^{a} {e}^{iq Φ} \qquad ( ( 11 )$$

$${C}_{q}^{a} = \frac{1}{2 π} {\int }_{- π}^{π} {e}^{i Θ ( a , Φ )} {e}^{- iq Φ} , \qquad ( ( 12 )$$

The complex field pattern can be retrieved from the first order term h₁(x, y) if the identity C₁^{a}=Aa is satisfied for a positive value of A. This requirement can be denoted as the signal encoding condition. Sufficient and necessary conditions to fulfill this requirement can be given below.

$${\int }_{- ∞}^{∞} sin [ Θ ( a , Φ ) - Φ ] d Φ = 0 , \qquad ( ( 13 )$$

$${\int }_{- ∞}^{∞} cos [ Θ ( a , Φ ) - Φ ] d Φ = 2 π Aa . \qquad ( ( 14 )$$

Θ(a, Φ) can be expressed in the form Θ=ƒ(a)sin(Φ). To obtain the Fourier series coefficients for this hologram, the Jacobi-Anger identity can be used:

$${e}^{i f ( a ) s i n ( Φ )} = {\sum }_{q = - ∞}^{∞} {J}_{q} [ f ( a ) ] {e}^{iq Φ} . \qquad ( ( 15 )$$

The resulting qth-order coefficient in this Fourier series can be given by

$${C}_{a}^{q} = {J}_{q} [ f ( a ) ] . \qquad ( ( 16 )$$

The encoding condition [C₁^{a}=Aa] is fulfilled if ƒ(a) is inverted by solving:

$${J}_{1} [ f ( a ) ] Aa . \qquad ( ( 17 )$$

Here, the maximum value of A which can be satisfied is 0.5819, which can correspond to the maximum value of the first-order Bessel function J₁(x). This can occur at x=1.84. Hence, the function ƒ(a) can be numerically solved to yield a value within [0,1.84]. Notably, the hologram can thus be implemented with phase modulation in the reduced domain [−0.586π, 0.586π] which can require an SLM with phase modulation depth between [0, 1.17π]. By solving for ƒ(a), the phase-only distribution Θ=ƒ(a) sin(Φ) can be obtained, pixel-by-pixel, across the entire hologram. Afterwards, a blazed grating can be added to this phase-profile in order to shift the desired signal from the zeroth order beam (on-axis noise). This can allow for noiseless reconstruction of the desired complex spectrum (at the Fourier plane) via a lens and spatial filter. Lastly, the filtered spectrum can be transformed to real space using a second lens in order to construct the target field (holographic scene) as depicted in FIG. 2D.

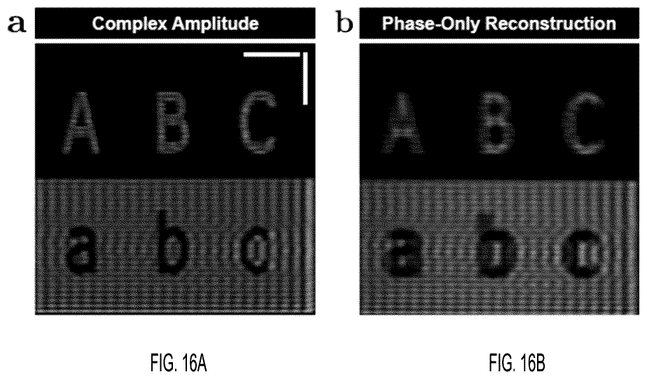

Complex amplitude reconstruction using a phase-only platform (e.g., phase retrieval) can be a general problem in holography that does not have a unique solution. Here, a comparison can be performed between the phase-only reconstruction technique and the complex amplitude modulated hologram. Due to the unitary (lossless) nature of the SLM pixels—which can modify the phase of incident light without altering its amplitude-complex—amplitude modulation can occur in the far-field region via interference. In this case the higher diffraction orders can act as loss channels that preserve the total incident energy. A 4-ƒ lens system can be placed after the SLM to generate the complex-amplitude spectrum in k-space via lens-1 and reconstruct the target hologram in real space at the focal plane of lens-2. This scheme can be used in Fourier-based digital holography. The reconstruction quality of a target complex hologram that makes use of the above technique to display the letters “A B C” can be evaluated. FIGS. 16A and 16B depict a comparison between the complex amplitude hologram at the plane of interest (FIG. 16A) with respect to its phase-only reconstruction (FIG. 16B). The two holograms can exhibit good agreement with slight defocusing in the phase-only copy which can be attributed in part to numerical inaccuracies in the discretization and computation of the fast Fourier transform (FFT).

FIGS. 16A and 16B illustrate complex amplitude modulation versus phase-only reconstruction. FIG. 16A illustrates generation of alphabetic letters “A B C” with complex amplitude modulation. The horizontal and vertical scale bars are 0.5 mm and 10 mm, respectively. FIG. 16B illustrates reconstruction of the same image using a phase-only computer-generated hologram.

The holographic light sheets can be fully described analytically. The method may not rely on any iterative algorithms to converge to the final CGH. This can help reduce the computation cost. The computation time can depend on the chosen parameters for each hologram. It can be highly affected by the number of holographic light sheets, the number of Frozen Waves within each sheet, and the number of Bessel terms in every Frozen Wave. To provide a quantitative measure, a Laptop processor Intel(R) Core(TM) i7-8650U CPU 1.9 GHz, 2112 Mhz, 4 Cores can be used. With these specifications it can take roughly 8 minutes to compute the CGH for the 3D sphere depicted in FIGS. 11A-11C. The latter can include 8 holographic light sheets each containing 30 Frozen Waves. The computation time can roughly scale linearly with the number of Frozen Waves. Real-time holography can readily be performed at the current stage by displaying prerecorded holograms.

FIGS. 17A-17C illustrate the energy distribution in holographic light sheets. FIG. 17A illustrates the evolution of the transverse profile along the optical path to construct the 2D sheet. The target image can be formed as a result of the energy exchange between the center sheet and its peripheral rings. FIG. 17B illustrates several longitudinal cuts of the generated pattern. While the target profile can be accurately constructed at the x-z plane, the adjacent planes can also contain undesired residual energy which becomes more pronounced in the vicinity of the plane of interest. Unlike multiplane Fresnel holography, however, the inter-plane spacing can be uniform. FIG. 17C illustrates the experimental reconstruction of 4 digits projected in 3D with inter-layer spacing of 0.468 mm. The observed cross talk can be mitigated by increasing the separation between the layers or by adding random phase noise to each image.

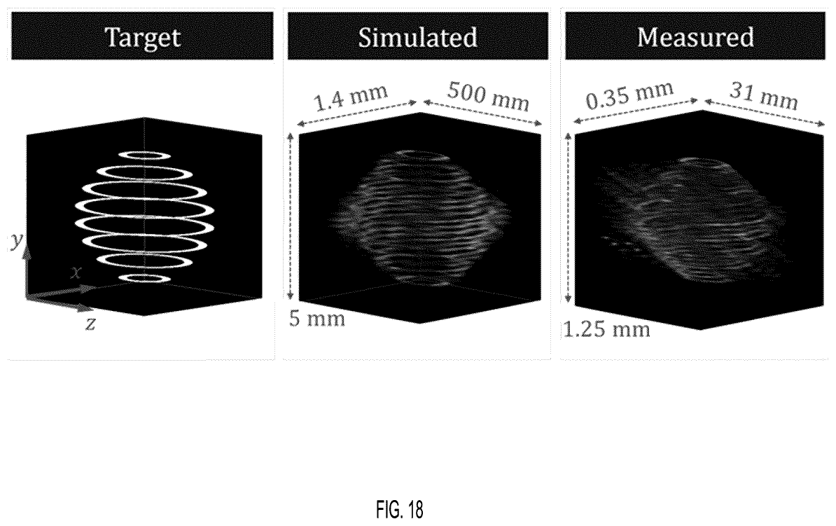

FIG. 18 illustrate the experimental reconstruction of a 3D hollow sphere while sampling intermediate layers. The sphere can include 8 equally-spaced rings. The simulated and measured holographic sphere can be reconstructed by sampling the 8 layers of interest plus two additional layers in between. The measured pattern can be in good agreement with the simulated one, albeit projected over a smaller volume due to the 4:1 demagnification introduced by the 4-f lens system. This hologram can be viewed from different angles.

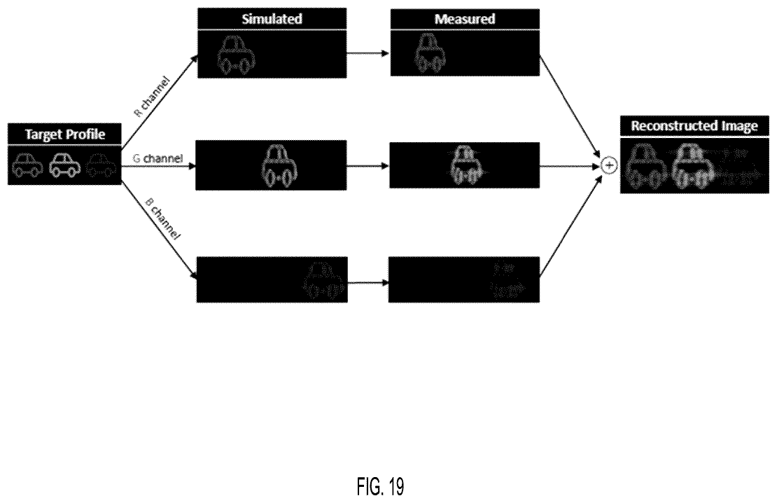

FIG. 19 illustrates multi-chromatic holographic light sheets. By multiplexing three 2D sheets with RGB information, a colored image can be generated. A proof-of-concept of three car cartoons can be shown. The measurements are false-colored (e.g., the target profiles of the three RGB channels can be generated at 532 nm wavelength, sequentially, with the SLM). Nevertheless, advanced wavefront shaping tools such as dispersion-engineered metasurfaces can potentially be deployed to realize all three profiles, simultaneously, thereby constructing true multi-chromatic holographic sheets. This can stem from the metasurface's ability to impart an independent phase profile on each wavelength with a single interaction.

FIGS. 20A and 20B illustrate construction of 3D dark regions. FIG. 20A illustrates a volumetric region of darkness, hollow sphere, for example, can be realized via the superposition of co-propagating non-diffracting modes which destructively interfere over the volume of interest. Transverse cuts of the constructed pattern confirm the existence of dark regions with high contrast. Structured dark can exhibit interesting physical behavior as it is not subject to the diffraction limit and has been used in metrology with nanometer precision. FIG. 20A illustrates volumetric regions of bright light (e.g., a holographic sphere) can be reconstructed using the same design methodology via constructive interference. Experimental validation of the latter using a spatial light modulator is shown. The scale bar is 10 mm.

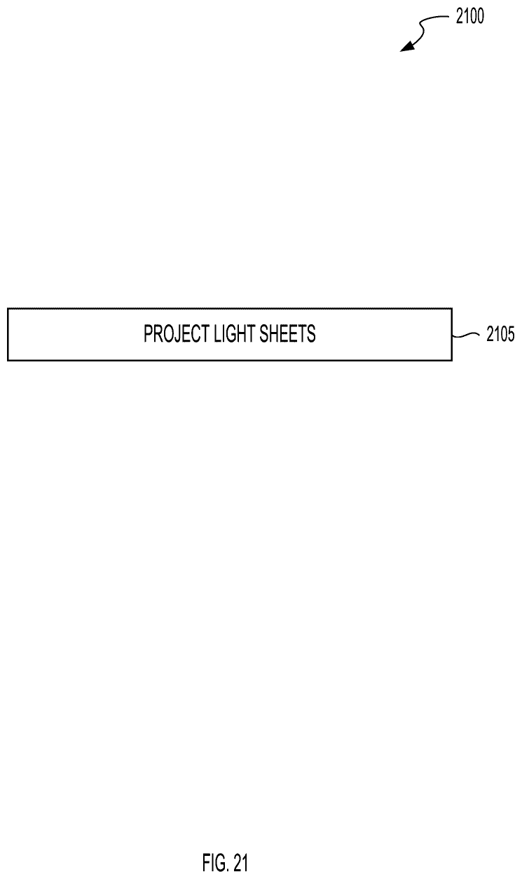

FIG. 21 illustrates a method 2100 of forming light sheets. The method 2100 can include projecting light sheets (BLOCK 2105). For example, the method 2100 can include projecting, by a wavefront-shaping device, one or more light sheets. The one or more light sheets can be projected along an optical path. The one or more light sheets can include one or more light threads. Each of the one or more light threads can be non-diffracting and structured along the optical path. At least one plane of the one or more light sheets can be non-parallel to a plane of the wavefront-shaping device.

The method 2100 can include controlling, by the wavefront-shaping device a phase of light. The method 2100 can include controlling, by the wavefront-shaping device an intensity of light. The method 2100 can include controlling, by the wavefront-shaping device polarization of light. At least one plane of the one or more light sheets can be parallel to the optical path. Each of the one or more light threads can be formed from a superposition of non-diffracting beams. The method 2100 can include spatially reconstructing a three-dimensional object by the one or more light sheets.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources. The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, microprocessors, and any one or more processors of a digital computer. A processor can receive instructions and data from a read only memory or a random access memory or both. The elements of a computer are a processor for performing actions in accordance with instructions and one or more memory devices for storing instructions and data. A computer can include, or be operatively coupled to receive data from or transfer data to, or both, one or more mass storage devices for storing data, e.g., magnetic, magneto optical disks, or optical disks. A computer need not have such devices. Moreover, a computer can be embedded in another device, e.g., a personal digital assistant (PDA), a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The implementations described herein can be implemented in any of numerous ways including, for example, using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to or receive communications from other devices. The display unit(s) may be provided, for example, to allow a user to view various information in connection with execution of the instructions. The user input device(s) may be provided, for example, to allow the user to make manual adjustments, make selections, enter data or various other information, or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the solution discussed above. The computer readable medium or media can be transportable, such that the program or programs stored thereon can be loaded onto one or more different computers or other processors to implement various aspects of the present solution as discussed above.

The terms “program” or “software” are used herein to refer to any type of computer code or set of computer-executable instructions that can be employed to program a computer or other processor to implement various aspects of embodiments as discussed above. One or more computer programs that when executed perform methods of the present solution need not reside on a single computer or processor, but may be distributed in a modular fashion amongst a number of different computers or processors to implement various aspects of the present solution.

Computer-executable instructions may be in many forms, such as program modules, executed by one or more computers or other devices. Program modules can include routines, programs, objects, components, data structures, or other components that perform particular tasks or implement particular abstract data types. The functionality of the program modules can be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system, comprising:
a wavefront-shaping device configured to project one or more light sheets along an optical path, the one or more light sheets comprising one or more light threads;
wherein each of the one or more light threads is non-diffracting and structured along the optical path; and
wherein at least one plane of the one or more light sheets is non-parallel to a plane of the wavefront-shaping device.

2. The system of claim 1, wherein the at least one plane of the one or more light sheets is parallel to the optical path.

3. The system of claim 1, wherein each of the one or more light threads is formed from a superposition of non-diffracting beams.

4. The system of claim 1, wherein the one or more light sheets comprise:
a first light sheet;
a second light sheet separated from the first light sheet by a first distance; and
a third light sheet separated from the second light sheet by a second distance;
wherein the first distance and the second distance are equal.

5. The system of claim 1, wherein the one or more light sheets comprise:
a first light sheet defined by a first plane; and
a second light sheet proximate the first light sheet and defined by a second plane;
wherein the first plane and the second plane are perpendicular to the plane of the wavefront-shaping device.

6. The system of claim 5, wherein the first plane is non-parallel to the second plane.

7. The system of claim 1, wherein the wavefront-shaping device comprises at least one of: a diffractive optic, a spatial light modulator, a metasurface, or a digital micromirror device.

8. The system of claim 1, further comprising:
one or more transparent sheets;
wherein at least one plane of the one or more transparent sheets is non-parallel to the plane of the wavefront-shaping device; and
wherein the one or more transparent sheets are configured to scatter light from the one or more light sheets.

9. The system of claim 1, wherein at least one of the one or more light sheets is curved.

10. The system of claim 1, wherein the wavefront-shaping device is configured to control at least one of a phase, an intensity, or polarization of light.

11. The system of claim 1, wherein each of the one or more light threads comprises light having one or more wavelengths.

12. The system of claim 1, wherein each of the one or more light threads comprises light having one or more wavelengths over the visible or invisible spectrum.

13. The system of claim 1, wherein the one or more light sheets comprise:
a first light sheet; and
a second light sheet separated from the first light sheet by a distance in a range of one wavelength to 10,000 times the wavelength.

14. The system of claim 1, wherein a three-dimensional object is spatially reconstructed by the one or more light sheets.

15. The system of claim 1, wherein the one or more light sheets comprise:
a first light sheet;
a second light sheet separated from the first light sheet by a first distance; and
a third light sheet separated from the second light sheet by a second distance;
wherein the first distance is different from the second distance.

16. The system of claim 1, wherein each of the one or more light threads is formed from a superposition of localized beams.

17. A method, comprising:
projecting, by a wavefront-shaping device, one or more light sheets along an optical path, the one or more light sheets comprising one or more light threads;
wherein each of the one or more light threads is non-diffracting and structured along the optical path; and
wherein at least one plane of the one or more light sheets is non-parallel to a plane of the wavefront-shaping device.

18. The method of claim 17, comprising:
controlling, by the wavefront-shaping device, at least one of a phase, an intensity, or polarization of light.

19. The method of claim 17, wherein the at least one plane of the one or more light sheets is parallel to the optical path.

20. The method of claim 17, wherein each of the one or more light threads is formed from a superposition of non-diffracting beams.
